(19) United States
(12) Patent Application Publication
(10) Pub. No.: US 2010/0010880 A1
(43) Pub. Date: Jan. 14, 2010

(54) PERFORMANCE OBSERVATION, TRACKING AND IMPROVEMENT SYSTEM AND METHOD

(75) Inventors: Michael D. TOTH, York, PA (US); Anthony MATOUS, Blairsville, PA (US); Charles ADAMCHIK, Blairsville, PA (US)

Correspondence Address: MCNEES WALLACE & NURICK LLC, 100 PINE STREET, P.O. BOX 1166, HARRISBURG, PA, 17108-1166, US

(73) Assignee: LEARNING SCIENCES INTERNATIONAL, Blairsville, PA (US)

(21) Appl. No.: 12/169,752

(22) Filed: Jul. 9, 2008

(51) Int. Cl. G06Q 10/00

(52) U.S. Cl. 705/11

(57) ABSTRACT

A growth cycle includes frequent observations and ongoing communication in a professional growth cycle. The professional growth cycle includes a walk-though, feedback, and professional reflection and implementation/application. A computer network system for conducting observations of individual professionals and administering observation results includes an observation software module to generate from a predetermined list of learners a listing of at least one learner for a scheduled observation event by a predetermined observer. Predetermined options are selectable by the observer related to the observation event. A scheduling module is in data communication with a calendar module. The scheduling module is configured to enter data and extract data associated with scheduled observation events from the calendar module. An observation criteria module is configured to generate observation criteria for guiding the observer in conducting the observation event.

### FIELD OF THE INVENTION

The present disclosure generally relates to electronic, web-hosted collecting and managing of human performance data to develop and enhance the skills of individuals in their professional practice.

### BACKGROUND OF THE INVENTION

Organizations rate the performance of individuals within the organization in order to accurately and appropriately monitor performance, reward good performers, and provide development assistance, training, or counseling to individuals to improve their performance. Generally, these performance assessment and appraisal systems are “paper” based and cumbersome, resource intensive, and time consuming. Prior known interactive systems are limited to providing for the staffing of various projects, or for the timing and reporting of projects.

Human resource functions of organizations have been frustrated in the methods available to assess and appraise performance of employees within their organizations. A number of problems existed with prior art systems, including non-compliance with deadlines, failure to conduct face-to-face performance reviews with the employee, inadequate quality of the appraisal and feedback are highly variable even between comparable employees, the risky ability for the supervisor or manager to express objectives in any terms (which could be, for example, vague, harsh, inappropriate, and inconsistent), inaccuracy of performance reviews due to delayed time between employee behavior and the review (existing performance assessment and appraisal is not an on-going process in that reviews usually occur at most every six months, wherein a behavior could be remote from the actual feedback received; possibility of surprise to the employee due to a lag between the time of the behavior and the review), guidance may not be provided to the employee ahead of time regarding job or role expectations, the employee is not exposed to the expected objectives other than during a review, the possibility of vast differences within the organization of what is expected of employees with roughly the same positions, roles, or responsibilities, or lack of access to developmental tools to improve performance or further develop the employee as needed and separation of the performance review and assessment process from the necessary development training process, lack of integration between behaviors noted for improvement, and availability of recommended training, and the review process takes a long time and is resource intensive.

In addition, human resource methods and systems have not included an integrated plan for growth or an integrated system or method permitting assessment and evaluation software to be interoperated with calendar functions allowing algorithms to track compliance and identifying completion of certain actions meeting predetermined objectives.

The inadequacy of human resource methods and systems is especially prevalent in the teaching profession. In the teaching profession, most organizations are not profit-driven and successful improvement is an intangible result that is difficult to quantify.

What is needed is a system and method permitting preparation and follow-up activities to expand the knowledge and expertise of professionals at multiple levels, at multiple facilities, having different skills, and having different goals, wherein the system and/or method includes performing frequent onsite observations, conducting ongoing communication, and proceeding to an immediate and explicit feedback step upon following an observation and advancing professional development.

Intended advantages of the disclosed systems and/or methods satisfy one or more of these needs or provides other advantageous features. Other features and advantages will be apparent from the present disclosure. The teachings disclosed extend to those embodiments that fall within the scope of the claims, regardless of whether they accomplish one or more of the aforementioned needs.

### SUMMARY OF THE INVENTION

This invention provides a system and method permitting preparation and follow-up activities to expand the knowledge and expertise of professionals at multiple levels, at multiple facilities, having different skills, and having different goals, wherein the system and/or method includes performing frequent onsite observations, conducting ongoing communication, and proceeding to an immediate and explicit feedback step upon following an observation and advancing professional development.

According to one embodiment, a computer based system is provided for conducting observations of individual professionals and administering observation results in a professional growth cycle. The system includes an observation software module configured to generate from a predetermined list of learners a listing of at least one learner for a scheduled observation event by a predetermined observer. A number of predetermined action element options are selectable by the observer. Each of the action elements is related to the observation event. A scheduling module is in data communication with a calendar module. The scheduling module is programmed for an observer, learner or administrator to enter data and extract data associated with one or more scheduled observation events from the calendar module. An observation criteria module is arranged to generate observation a plurality of observation criteria for guiding the observer in conducting the observation event.

In another aspect the invention is directed to a computer implemented method of for individual and organizational professional development using a professional growth cycle including growth planning, training, observation, feedback, and improvement. The method includes providing an observer module, an observation module and an administrator module; through the observer module, generating over a computer network a listing of one or more observations to be performed by an observer on a predetermined date. The listing including at least one individual subject for observation, a calendar date of a scheduled observation associated with the individual subject and action selection elements. The method further includes performing at least one of the following steps: observing at least one of the individual subjects in a professional environment; viewing an observation calendar associated with the individual subject; accessing a collection of electronic observation forms; communicating with the individual subject via a conferencing module; and viewing an observation training module associated with an observation form for the individual subject.

Further aspects of the method and system are disclosed herein. The features as discussed above, as well as other features and advantages of the present invention will be appreciated and understood by those skilled in the art from the following detailed description and drawings.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 illustrates an exemplary teacher growth cycle.

FIG. 2 illustrates another exemplary teacher growth cycle.

FIG. 3 illustrates a schematic representation illustrating the aggregate affect associated with the collection of the information based upon the module of the present invention.

FIG. 4 illustrates an exemplary introductory webpage.

FIG. 5 illustrates one embodiment of an automated observation listing.

FIG. 6 illustrates another embodiment of an automated observation listing.

FIGS. 7-9 illustrate partial views of an electronic form for entry of observation data.

FIG. 10 illustrates an exemplary item help feature hyperlink from the observation form providing a rubric for an observation criteria.

FIG. 11 illustrates an exemplary item help feature hyperlink from the observation form providing coaching tips for an observation criteria.

FIG. 12 illustrates an exemplary resource hyperlink from the observation form providing an audio-visual model for an observation criteria.

FIG. 13 illustrates an exemplary observation calendar.

FIG. 14 illustrates an exemplary observation history chart.

FIG. 15 illustrates an exemplary scheduling tool for scheduling observations.

FIG. 16 illustrates an exemplary tool for accessing prior observation records.

FIG. 17 illustrates an exemplary conference summary tool.

FIG. 18 illustrates an exemplary self-observation tool.

FIG. 19 illustrates an exemplary growth plan.

FIG. 20 illustrates an exemplary embodiment of a hardware architecture system according to the present invention.

FIG. 21 illustrates a schematic diagram representing of relationships between various components and roles according to the present invention.

FIG. 22 illustrates an exemplary embodiment of an intermediary administrative role selection feature

FIG. 23 illustrates an exemplary observer account administration feature.

FIG. 24 illustrates an exemplary learner account administration feature.

FIG. 25 illustrates an exemplary growth plan administration feature.

FIG. 26 illustrates an exemplary observer action menu feature.

Wherever possible, the same reference numbers will be used throughout the drawings to represent the same parts.

### DETAILED DESCRIPTION OF THE INVENTION

The present invention discloses a comprehensive professional development system for tracking performance levels of professionals, and to provide training and development resources for continued professional growth of individuals at all layers within an organization, including employees, supervisors, lower-level and upper-level managers, leaders, and top executives. At the organization level, objective expectations can be set for learners according to their professional roles, responsibilities, and individual learning needs by assigning the appropriate observation forms.

The system of the present invention may also be used for self-reflection and improvement through the self-observation process. Additionally, peer-to-peer observations and mentor-mentee observations can be conducted for 360 feedback. In human resources, 360-degree feedback, also known as ‘multi-rater feedback’, ‘multisource feedback’, or ‘multisource assessment’, is employee development feedback that comes from all around the employee. “360” refers to the 360 degrees in a circle.

Opportunities for self-improvement based on observed competencies are available through professional development resources in the system, including online courses, files, videos, etc. that can be attached to each observation criteria or “look-for”.

Observations collected by individual learners may be used in the present invention to establish baseline data in order to track progress evaluation over time and improvements across multiple years. Baseline data may also provide the means to evaluate the effectiveness of professional development programs within an organization and their direct impact on actual performance during practice. Additionally, observable behaviors that measure growth in professional practice may be correlated with quantifiable results. For example, teacher instructional practice can be correlated with student achievement data, employee performance can be correlated with financial or production volume, etc.

Learners may participate in developing their own professional growth plans, by use of the present invention, to bridge the gap between current and target rubric levels, incorporating self improvement tools and resources. Immediate and ongoing feedback between observers and learners deepens conversations around professional practice to promote continuous growth and allows the growth plan to be regularly monitored to ensure success. The growth plan can be constructed to automatically apply an algorithm to determine that a goal is achieved, for example, when the learner has scored a predetermined or specified rubric level a predefined number of times within a predetermined number of observations (e.g., the last “x” times, wherein x is an integer value). All three values (rubric level, frequency, and time span) may be configurable, e.g., by an administrator.

The present invention now will be described more fully hereinafter with reference to the accompanying drawings, in which a preferred embodiment of the invention is shown. This invention may, however, be embodied in many different forms and should not be construed as limited to the embodiments set forth herein; rather, these embodiments are provided so that this disclosure will be thorough and complete and will fully convey the scope of the invention to those skilled in the art.

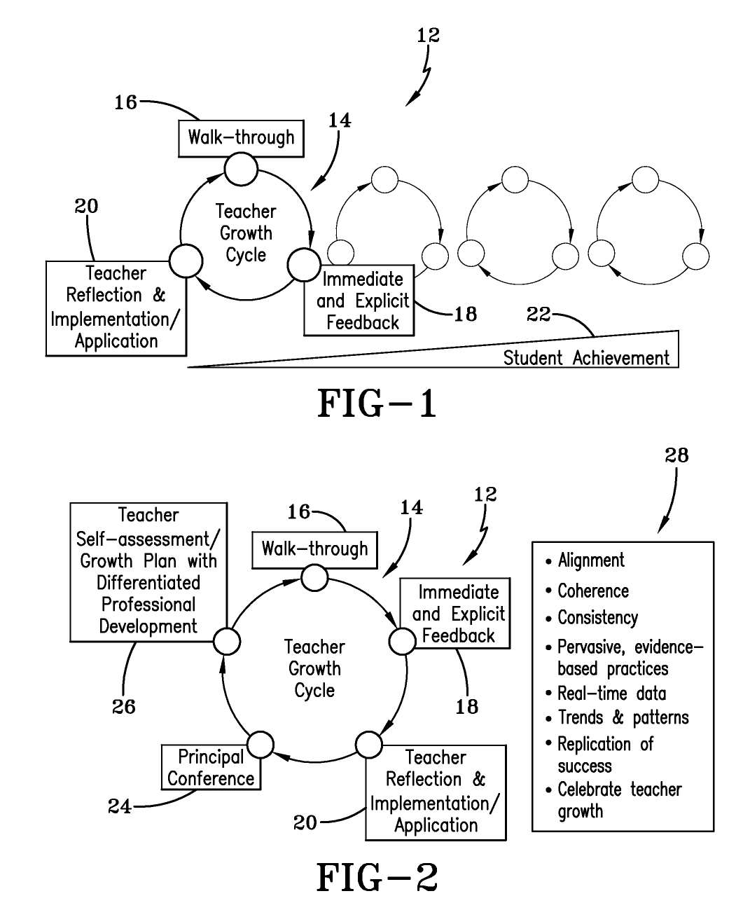

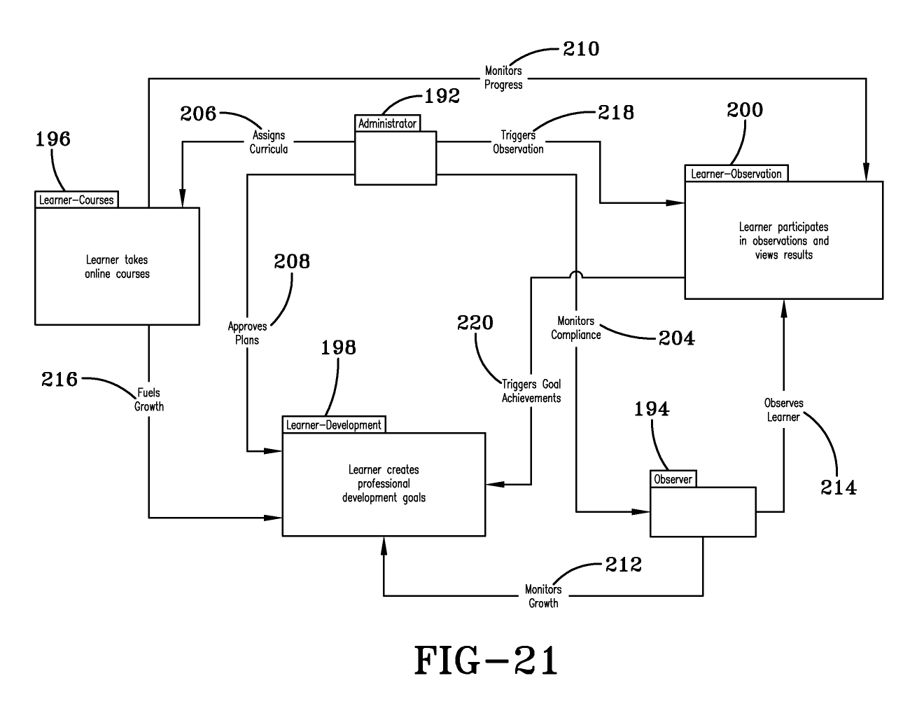

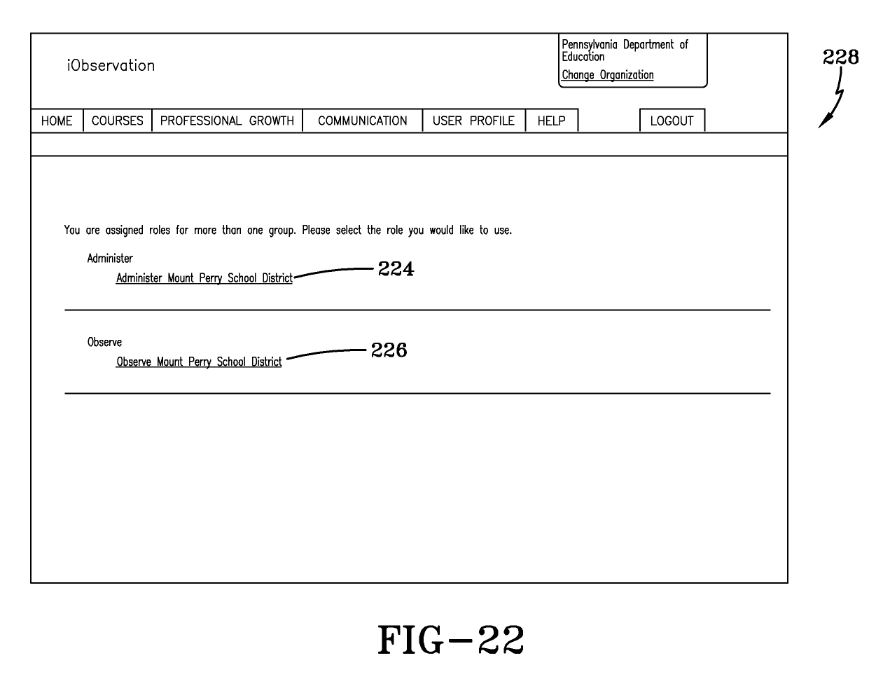

FIG. 1 illustrates an exemplary embodiment of the growth cycle 12. In this embodiment, the growth cycle 12 includes a professional growth cycle 14 identified as a teacher growth cycle. The exemplary methods and systems of employee performance observation and assessment, as disclosed herein, is applied in the context of teaching professionals, however, it will be readily appreciated by those skilled in the art that the methods and systems disclosed herein will have applications in other professions, within the scope of the of the present invention and the appended claims. In the embodiment illustrated in FIG. 1, the professional growth cycle 14 starts at a walk-through or observation event 16, proceeds to an immediate and explicit feedback step 18, and advances to a professional reflection and implementation/application step 20. In one embodiment, the growth cycle 12 is repeated periodically on a predetermined schedule or regimen, which, over time is determined to result in increasing student achievement 22. The observation event 16 provides the ability for school administrators 192 (described in FIG. 21) and observers 194 (described in FIG. 21) to align instructional practice with district objectives. The results of the observation event 16 may be immediately memorialized on an electronic observation form (not shown), to provide professionals, e.g., teaching professionals, with results and feedback. The feedback may include including rubrics and growth tools.

Referring next to FIG. 2, another exemplary embodiment of the growth cycle 12 includes additional steps in the professional growth cycle 14. In the embodiment of FIG. 2, the professional growth cycle 14 again begins at the observation event 16, proceeds to the immediate and explicit feedback step 18, and proceeds to the professional reflection and implementation/application step 20. The professional reflection and implementation/application step 20 is followed by a principal conference step 24 and next a professional self-assessment/growth plan with differentiated professional development step 26. The growth cycle 12 of FIG. 2 achieves one or more growth results 28. Growth results 28 may include alignment, coherence, consistency, pervasive evidence-based practices, real-time data, trends and patterns, replication of success, and celebrated professional growth.

The alternate embodiments of growth cycle 12, represented by FIGS. 1 and 2, are based on a continuous cycle of frequent observations whereby observers 194 provide immediate, specific, and relevant feedback for learners to reflect upon and plan for application; ongoing conversations follow between observers 194 and learners around professional practice for growth. FIGS. 1 and 2 above represent alternate embodiments of a teacher growth cycle; however, the growth cycle 12 can be applied across any discipline.

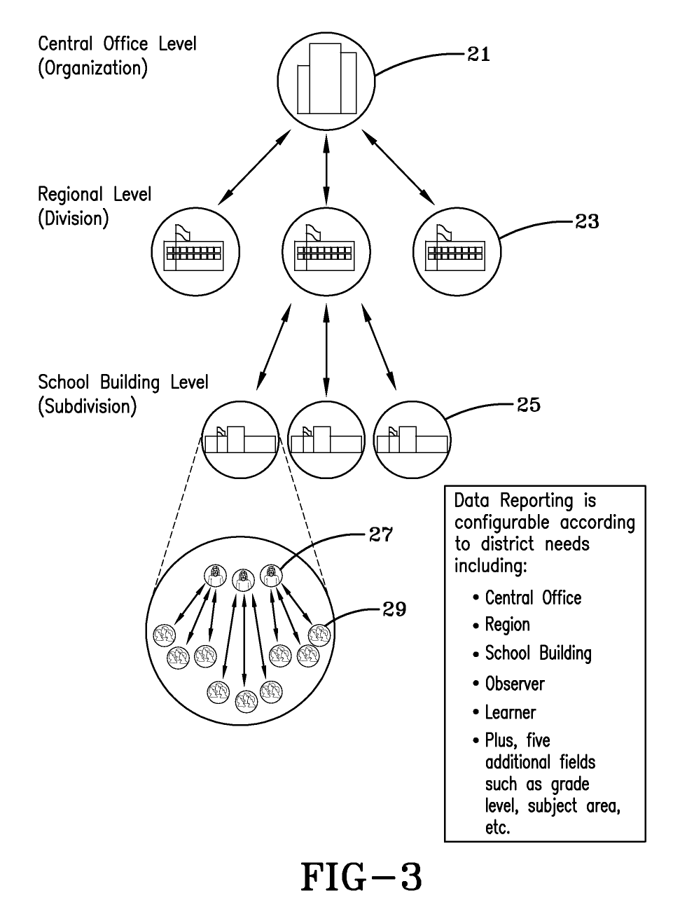

FIG. 3 illustrates a schematic diagram representing the aggregate affect associated with the collection of the information based upon the module of the present disclosure. All of the information gathered through the module discussed hereinafter can be compiled and reported based upon criteria associated with the information. Depending upon the settings of the individual user, the information displayed to a specific user may be specific to an organization, e.g., a school district, central office level 21, a regional level or subdivision 23 of the central office 21, e.g., classification of schools (i.e. primary, secondary, junior high school, middle school, high school, vocational school, homeschool), a school building level or subdivision 25, a specific manager/observer 27, and/or a specific professional/learner 29. Data reporting may be configurable according to district level needs including central office 21, regional level 23, school building level 25, an observer 27, a learner 29 and other data reporting subdivisions, e.g., grade levels, subject areas and similar groupings for data reporting which will be readily appreciated by persons skilled in the art.

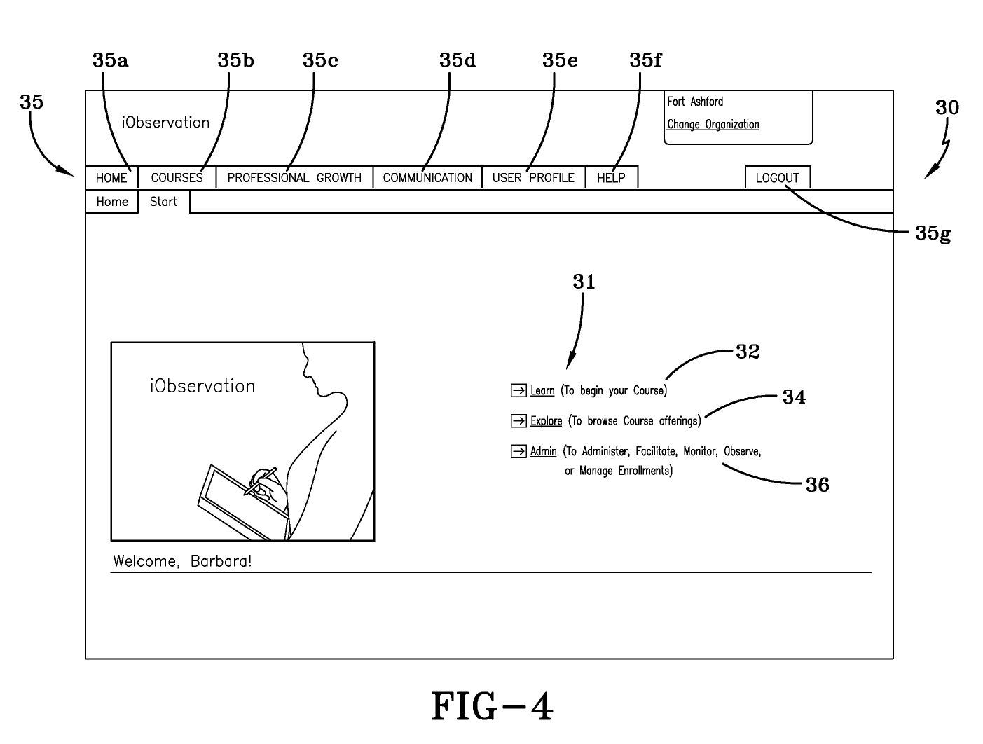

FIGS. 4 through 24 below represent a web, or communications network, application of multiple interconnected modules embodying an exemplary observation and assessment method of the present invention. The method or application may be implemented over the Internet via secure access, through an intranet, or via other network configurations as discussed in greater detail below. The method or application may involve employing algorithms to perform the functions described in FIGS. 4 through 24.

Referring next to FIG. 4, an exemplary embodiment of a welcome screen or introductory screen 30 provides start module 31 for implementing the growth cycle 12. In this embodiment, a predetermined set of selection elements 32, 34 and 36 permits a user to login and access the appropriate functions of the present invention. The selection elements 32, 34, 36 include a learn selection element 32, an explore selection element 34, and an administrative (admin) selection element 36. The learn selection element 32 permits a user to access courses and course-related information. The explore selection element 34 permits a user to access a list of course offerings. The list of course offerings may be customized for the individual associated with the login information. Alternately, the list of course offerings may be a complete listing applicable to all learners or observed individuals. The admin selection element 36 permits a user to access observation module 38, e.g., administer, facilitate, monitor, observe or manage.

Various navigation elements 35 are represented as file tabs, which provide the user with additional navigation options, e.g., home page 35a, courses 35b, professional growth 35c, communication 35d, user profile 35e, help 35f and logout 35g, may be displayed. More or less navigation elements may be provided. Also, web browser (e.g., Windows Internet Explorer®) menus, address bars and plug-in features are available in the web application, as are well know to those skilled in the art.

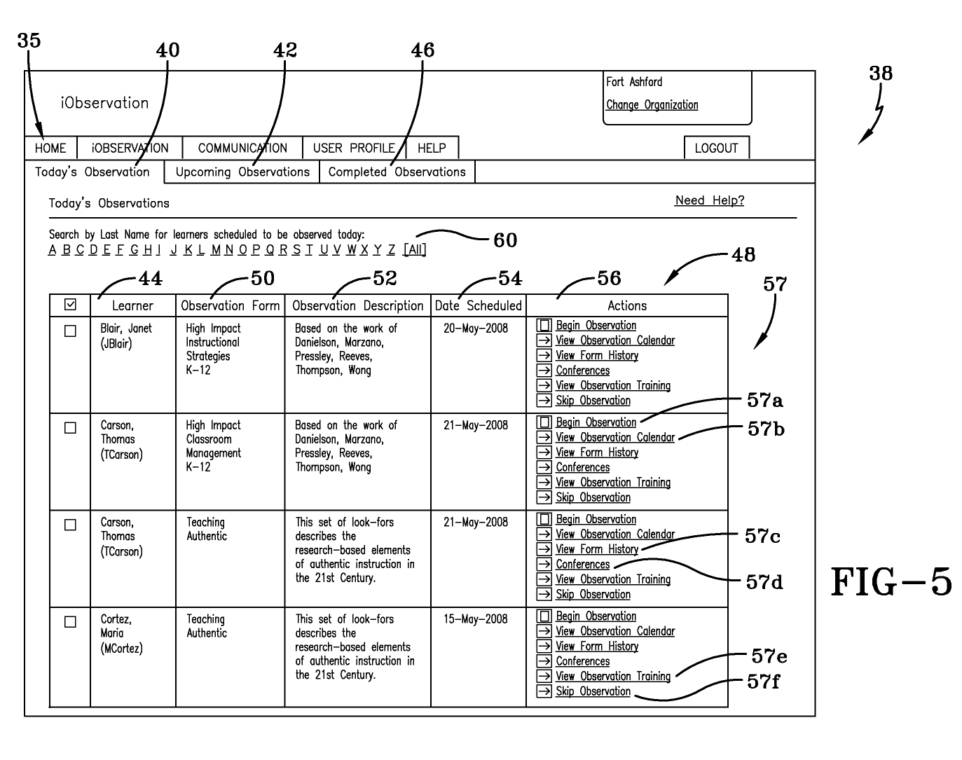

Referring next to FIG. 5, an exemplary embodiment of the observation module 38 accessed by selecting the administration (admin) selection element 36 is shown. In FIG. 5, the observation module 38 illustrated is an automated observation listing. The observation module 38 includes a today's observations selection element 40, an upcoming observations selection element 42, and a completed observations selection element 46, as well as the standard navigation tabs 35. A tabular list 48 includes a first column 44. First column 44 identifies learners that are associated with the observer. List 48 also includes second column 50 that identifies one or more predetermined observations forms associated with the learner identified in a corresponding row of first column 44. A third column 52 identifies an observation description that provides a description of the contents of the associated observation form from second column 50. A fourth column 54 indicates a date scheduled for the observation of the learner identified in the corresponding row of table 48. A fifth column 56 provides a set of action selection elements 57 that enable the observer to select various actions to take, including a begin observation selection element 57a for opening a new or existing observation form for the corresponding learner; a calendar selection element 57b for opening an observation calendar associated with the corresponding learner; a history selection element 57c for viewing the history of forms in the corresponding learner's records; a conferences selection element 57d for viewing notes of prior conferences corresponding to the learner; a view observation training selection element 57e for observers 194 to learn to effectively conduct observations and for learners to access professional development resources; and a skip observation selection element 57f for the observer to delete the corresponding learner from the table 48. The table listing 48 of today's observations may be sortable by the predetermined observation form column 50 (the first column), the observation description column 52 (the second column), the date scheduled column 54 (the third column), selected selection boxes column 58 (the fourth column), and combinations thereof. A search facility 60 may be provided for the observer to search the table 48 by the initial of a learner's last name.

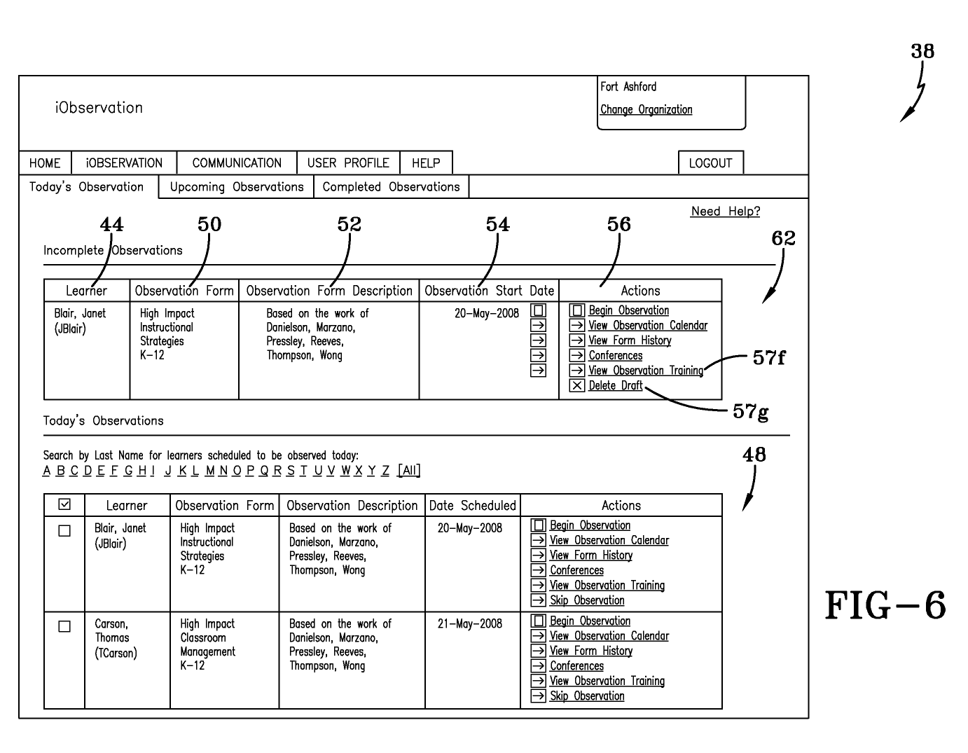

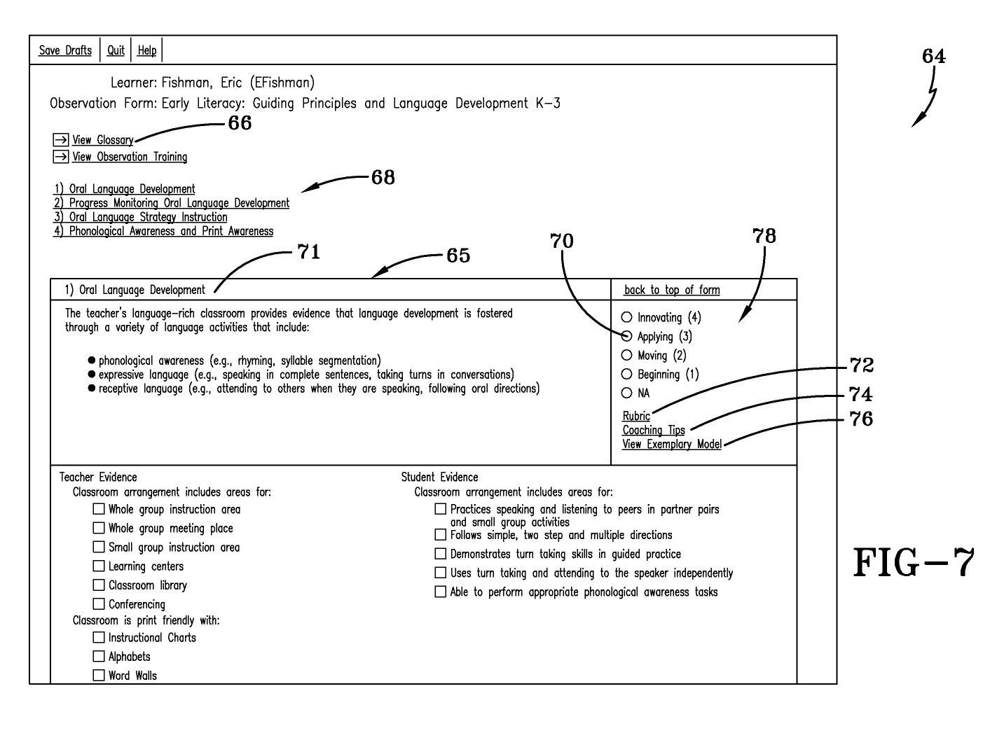

Referring next to FIG. 6, an exemplary embodiment of a screen providing observation module 38 accessed by selecting the today's observations selection element 40 is shown. A table 62 identifying incomplete observations is provided in addition to the table 48. As shown, one learner in column 44 is identified in the table 62 of incomplete observations but those skilled in the art will understand that the table 62 may include additional rows identifying more than one learner in column 44, or may have no learners identified, depending upon the number of incomplete observations. In the embodiment illustrated by FIG. 6, column 56 includes the same selection elements 57a- 57e, i.e., “Begin Observation” 57a “View Observation Calendar” 57b, “View Form History” 57c, “Conferences” 57d, “View Observation Training” 57e, and “Skip Observation” 57f. Another selection element, 57g, is provided to enable the observer to delete a draft of an observation. More or less action selection elements 57 may be added and/or removed.

Referring to FIGS. 7 through 9, exemplary embodiments of observation form module 64 accessed by selecting one of the action selection elements 57 are shown. In FIGS. 7-9 the observation form module 64 illustrated includes partial views of an electronic form for entry of observation data. In FIGS. 7 through 9, the selected action element is 57a, the “Begin Observation” action. The exemplary predetermined observation form 64 is entitled “Early Literacy: Guiding Principles and Language Development K-3”. Other forms include, but are not limited to, a “High Impact Instructional Strategies K-12” observation form, a “High Impact Classroom Management K-12” observation form, and a “Teaching Authentic” observation form. Those skilled in the art will understand that other forms are also used to perform observations, within the scope of the present invention. In an alternate embodiment, additional forms may be downloadable into a format permitting them to be used in a manner similar to that described herein. As used herein, forms generally refers to interactive electronic forms which are configured to receive data input, but forms may also include printed forms for recording data for later input to the observation system.

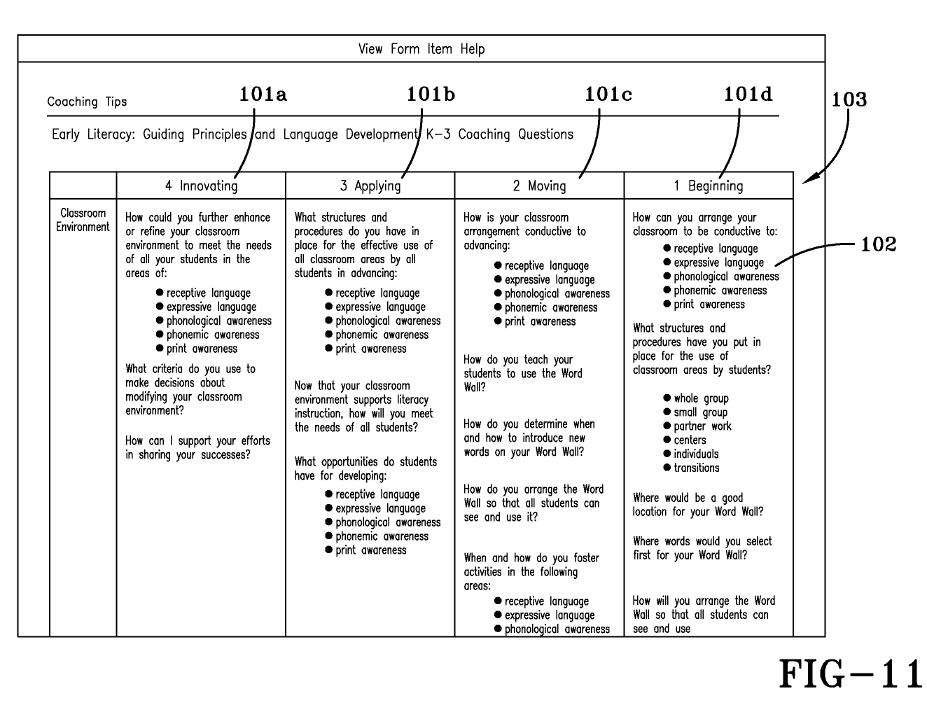

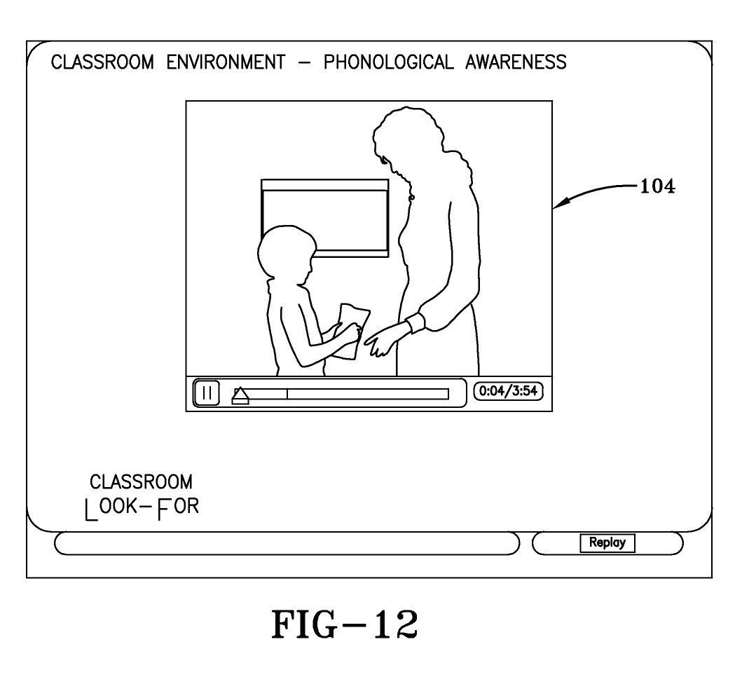

As illustrated in FIG. 7, the predetermined observation form module 64 includes a view glossary selection element 66 that enables the observer to access a glossary of terms relevant to performance evaluations, a listing 68 of observation criteria selection elements, a rating levels selection element 70 for the observer to select a performance level achieved by the associated learner; a rubric selection element 72 that enables the observer to access rubrics (see, e.g., FIG. 10) associated with the relevant topic described in the first column 71 of table 65, a coaching tips selection element 74 for accessing resources for a coaching tips (see, e.g., FIG. 11), and a view exemplary model selection element 76 (see, e.g., FIG. 12). The observation criteria selection elements in listing 68 may include “Oral Language Development,” “Progress Monitoring Oral Language Development,” “Oral Language Strategy Instruction,” and “Phonological Awareness and Print Awareness.” Those skilled in the art will readily appreciate that the listing 68 is not intended to be exhaustive, and that other observation criteria selection elements may be included or omitted from the listing 68. The observation criteria selection elements listing 68 corresponds with a ratings list 78 including the rating level selection element 70, the rubric selection element 72, the coaching tips selection element 74, and the view exemplary model selection element 76. In addition, the ratings list 78 includes information further explaining the observation criteria. In the embodiment illustrated by FIG. 7, the screen 64 further includes the action selection element 57e identified as “View Observation Training.” Selecting the “View Observation Training” action selection element 57e provides observers 194 and learners access to a version of the observation form specifically intended for training observers 194 on how to conduct effective observations using coaching tips, rubrics, videos, and other resources.

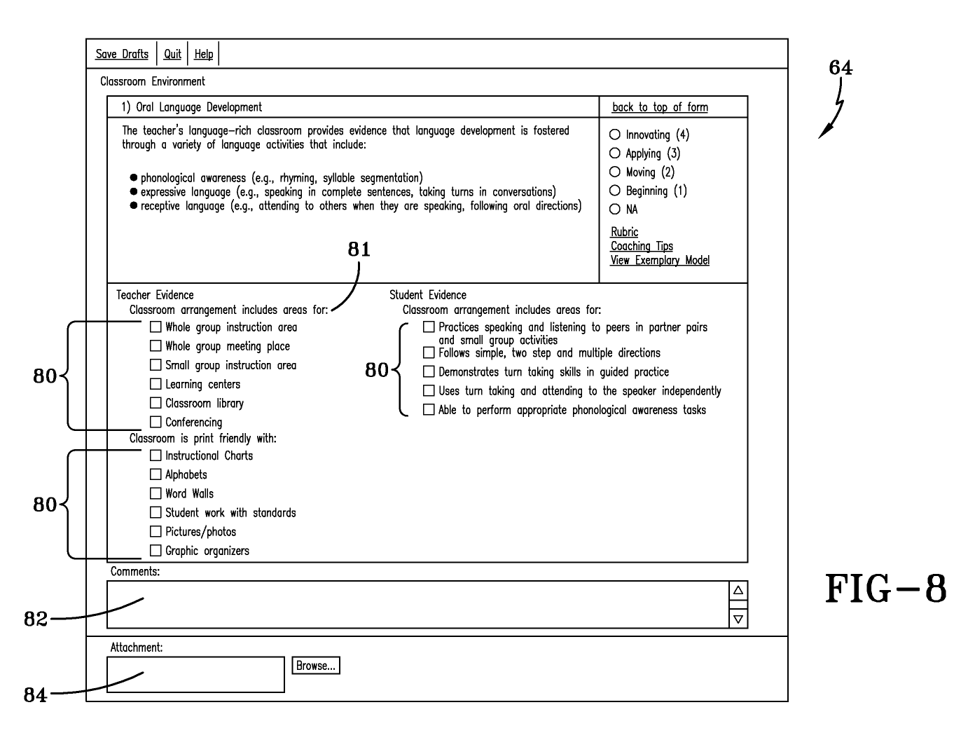

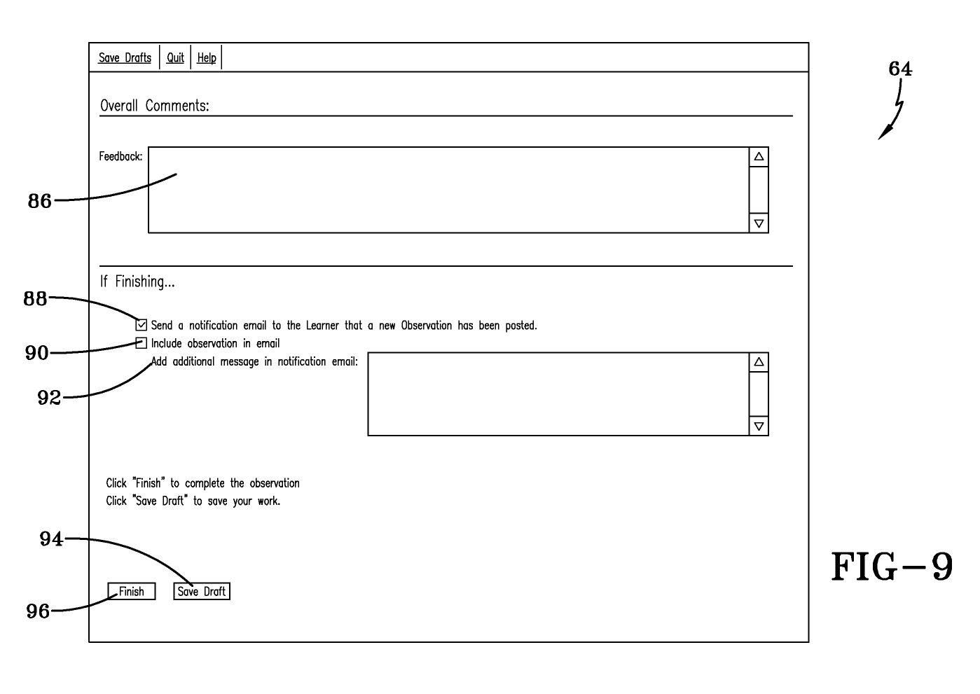

Referring next to FIG. 8, the predetermined observation form module 64 further may include one or more predetermined evidence lists 80 that are configured as checkbox listings. The observer is presented with a list of statements that evidence support for one of the rating levels selected by the observer for the scheduled observation. The observer may select or check any of the boxes 80 under a particular subheading 81, or may select none of the checkboxes 80 as appropriate. A textbox 82 may also be provided for entering observer comments, and an attachment feature 84 for attaching electronic files stored on the server 184 (FIG. 20), such as documents relevant to the observation, e.g., documents created offline for purposes of the observation.

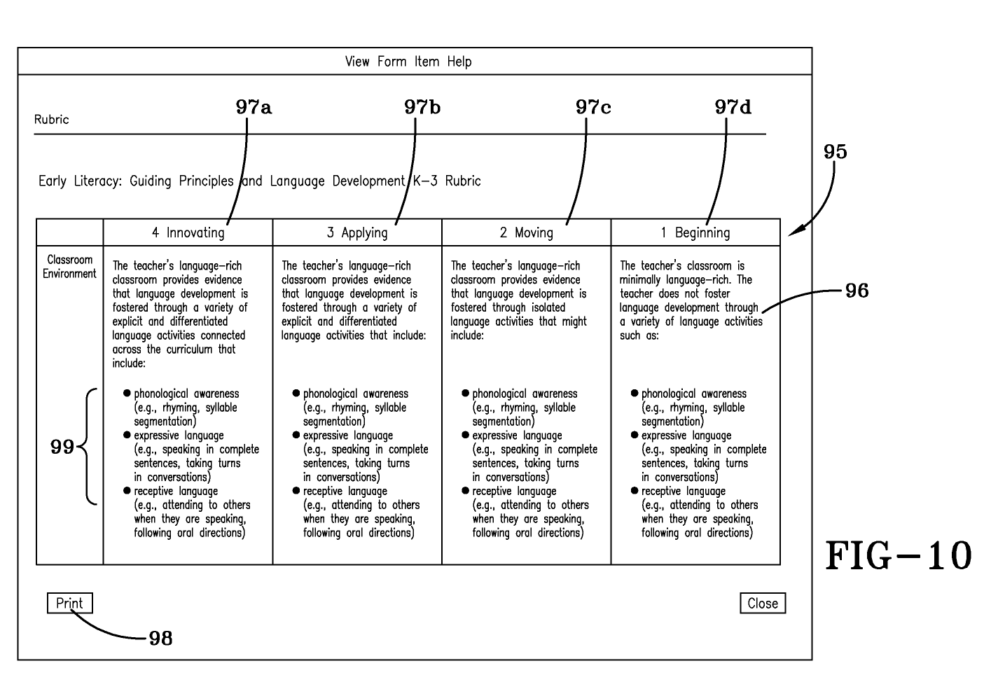

Referring to FIG. 9, the observation form module 64 further includes an overall comments textbox 86 for entry of feedback comments, a checkbox 88 for requesting email notification to the learner when a new observation is posted to the network, a checkbox 90 to indicate to include a copy of the observation results in the email sent to the learner, and a textbox 92 for providing an additional message in the notification email to the learner. The observation form module 64 further includes a save draft selection element 94, and a finish selection element 96.

Referring to FIG. 10, an exemplary embodiment of a screen providing rubric information 96 accessed upon selecting the rubric selection element 72 included in the observation form module 64 is shown. In FIG. 10, the rubric information 96 includes an exemplary item help feature hyperlink from the observation form providing a rubric for an observation criteria. As illustrated in FIG. 10, the rubric information 96 includes detailed explanations indicating the criteria for rating levels 148 (described in FIG. 15) corresponding to the ratings levels selection elements 70. In this embodiment, the rubric information 96 is specific to the observation form 64 entitled “Early Literacy: Guiding Principles and Language Development K-3 Rubric.” In other embodiments, the rubric information 96 corresponds with other predetermined observation forms 64. In yet other embodiments, the rubric information 96 is consistent between all predetermined observation forms 64.

The rating levels 148 are identified in a rubric table 95 including columns 97 identifying the numeric value of the rating levels 148 and the corresponding label. The rubric table 95 includes a column 97a entitled “4 Innovating” providing information for the observer 194 to rate the learner. As illustrated in column 97a, the observer 194 should give the learner a rating level 148 of “4 Innovating” if language development is fostered through a variety of explicit and differentiated language activities connected across the curriculum that includes rubric criteria 99. The rubric criteria 99 includes phonological awareness (e.g., rhyming, syllable segmentation), expressive language (e.g., speaking in complete sentences, taking turns in conversations), and receptive language (e.g., attending to others when they are speaking, following oral directions).

The rubric table 95 includes a column 97b entitled “3 Applying” providing information for the observer 194 to rate the learner. As illustrated in column 97b, the observer 194 should give the learner a rating level 148 of “3 Applying” if language development is fostered through a variety of explicit and differentiated language activities that include the rubric criteria 99.

The rubric table 95 includes a column 97c entitled “2 Moving” providing information for the observer 194 to rate the learner. As illustrated in column 97c, the observer 194 should give the learner a rating level 148 of “2 Moving” if language development is fostered through isolated language activities that might include the rubric criteria 99.

The rubric table 95 includes a column 97d entitled “1 Beginning” providing information for the observer 194 to rate the learner. As illustrated in column 97d, the observer 194 should give the learner a rating level 148 of “1 Beginning” if language development is not fostered through a variety of language activities such as the rubric criteria 99. In the embodiment illustrated in FIG. 10, the rubric information 96 can be opened, minimized, or modified in size to permit access to the rubric information 96 while an individual is completing the predetermined observation form 64. The embodiment illustrated in FIG. 10 further illustrates that the rubric information 96 can be printed by selecting a print selection element 98 or closed by selecting a close selection element 100.

Referring to FIG. 11, an exemplary embodiment of a screen providing coaching information 102 accessed upon selecting the coaching tips selection element 74 included in the observation form module 64 is shown. In FIG. 11, the coaching information 102 includes an exemplary item help feature hyperlink from the observation form providing coaching tips for an observation criteria. As illustrated in FIG. 11, the coaching information 102 includes detailed explanations indicating the tips for further developing professionals corresponding to the ratings levels 148. In this embodiment, the coaching information 102 is specific to the predetermined observation form 64 entitled “Early Literacy: Guiding Principles and Language Development K-3 Rubric.” In other embodiments, the coaching information 102 corresponds with other predetermined observation forms 64. In yet other embodiments, the coaching information 102 is consistent between all predetermined observation forms 64. The rating levels 148 are identified in a coaching table 103 including columns 101 identifying the numeric value of the rating levels 148 and the corresponding label. The coaching table 103 includes a column 101a entitled “4 Innovating” providing information for the observer 194 to coach the learner. As illustrated in column 101a, the observer 194 may ask learners with a rating level 148 of “4 Innovating” to consider how to further enhance or refine the classroom environment to meet the needs of all students in the areas of receptive language, expressive language, phonological awareness, phonemic awareness, and print awareness; what criteria the learner is using to make decisions about modifying the classroom environment; and how the observer 194 can support efforts in sharing the learners successes.

The coaching table 103 includes a column 101b entitled “3 Applying” providing information for the observer 194 to coach the learner. As illustrated in column 101b, the observer 194 should ask learners with a rating level 148 of “3 Applying” to consider what structures and procedures they have in place for the effective use of all classroom areas by students advancing in the areas of receptive language, expressive language, phonological awareness, phonemic awareness, and print awareness; how will they meet the needs of all students; and what opportunities do students have for developing the areas of receptive language, expressive language, phonological awareness, phonemic awareness, and print awareness.

The coaching table 103 includes a column 101c entitled “2 Moving” providing information for the observer 194 to coach the learner. As illustrated in column 101c, the observer 194 should ask learners with a rating level 148 of “2 Moving” to consider how their classroom arrangement is conducive to advancing the areas of receptive language, expressive language, phonological awareness, phonemic awareness, and print awareness; how they teach students to use the Word Wall (a word wall is a strategy used in teaching literacy, in which a list of core vocabulary words—often frequently recurring—is compiled on the classroom wall so that students can review the list on the wall as a warm-up activity before lessons begin and teachers can reinforce the words by pointing out the words on the Word Wall when encountered in a lesson); how they determine when and how to introduce words on their Word Wall; how do they arrange the Word Wall so that students can see and use it; and when and how do they foster activities in the areas of receptive language, expressive language, phonological awareness, phonemic awareness, and print awareness.

The coaching table 103 includes a column 101d entitled “1 Beginning” providing information for the observer 194 to coach the learner. As illustrated in column 101d, the observer 194 should ask learners with a rating level 148 of “1 Beginning” to consider whether they can arrange the classroom to be conducive to receptive language, expressive language, phonological awareness, phonemic awareness, and print awareness; what structures and procedures they have put in place for the use of classroom areas by students (e.g., whole group, small group, partner work, centers, individual, transitions); where would be a good location for their Word Wall; what words would they select first for their Word Wall; and how will they arrange the Word Wall so that all students can see and use it.

In the embodiment illustrated in FIG. 11, the coaching information 102 can be opened, minimized, printed, electronically copied, or modified in size to permit access to the coaching information 102 while an individual is completing the predetermined observation form 64 or while other computer applications are being used.

Referring to FIG. 12, an exemplary embodiment of a screen providing an example video 104 accessed upon selecting the view exemplary model selection element 76 included in the observation form module 64 is shown. In FIG. 12, the example video 104 includes an exemplary resource hyperlink from the observation form providing an audio-visual model for an observation criteria. In the embodiment illustrated in FIG. 12, the example video 104 illustrates a professional exercising the skill of phonological awareness. In one embodiment, the example video 104 is initially available. In another embodiment, the example video 104 is available upon being downloaded from a list of recommended videos. In the embodiment illustrated in FIG. 12, the example video 104 can be opened, minimized, or modified in size to permit access to the example video 104 while an individual is completing the predetermined observation form 64 or while another computer application is being used. The example video 104 can be used for the purpose of educating observers 194, administrators 192, and/or learners. In one embodiment, the example videos 104 are based upon the rating level 148 received by the learner in a previous observation. In other embodiments, the example videos 104 are consistent for all learners.

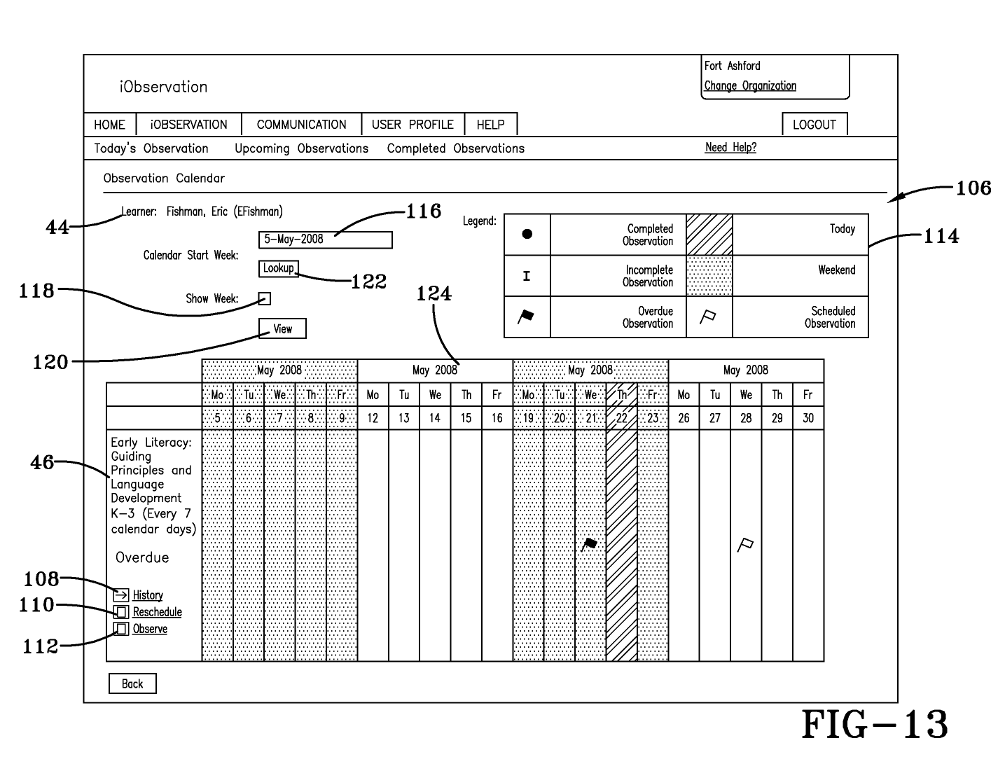

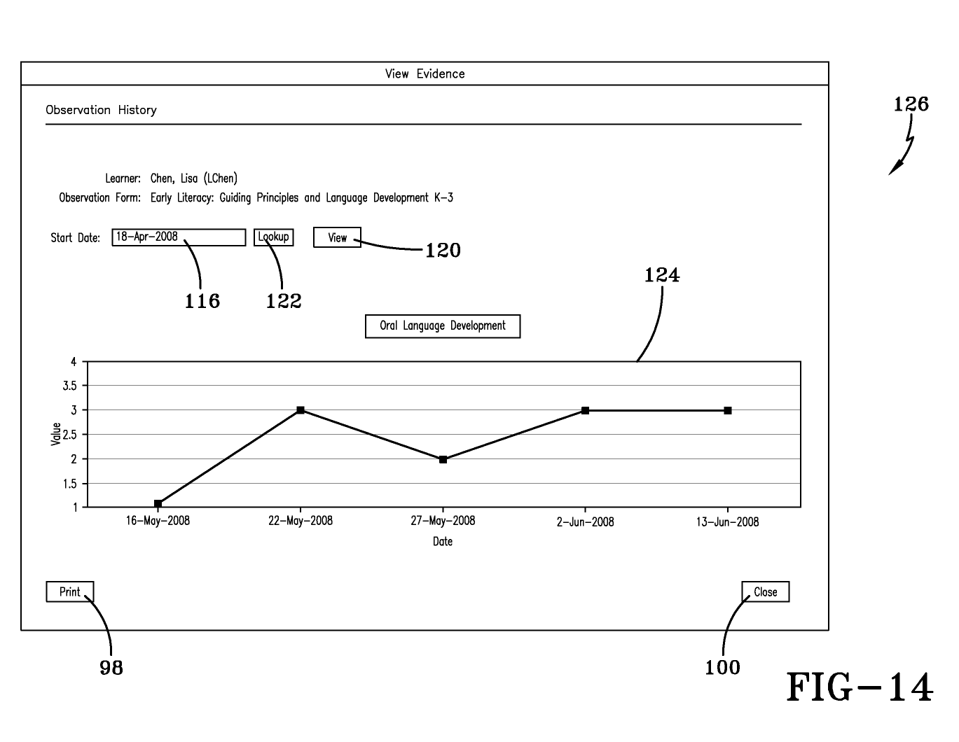

Referring to FIG. 13, an exemplary embodiment of a screen providing observation calendar module 106 accessed by selecting action selection elements 57a (FIG. 5). In FIG. 13, the observation calendar module 106 includes an exemplary observation calendar associated with the preselected learner 44. The observation calendar module 106 includes identification of the predetermined observation form 64, a history selection element 108, a reschedule selection element 110, an observe selection element 112, a legend 114, a calendar start week entry field 116, a show weekend selection element 118, a view selection element 120, a date lookup selection element 122, and a calendar output 124. The reschedule selection element 110 provides a module to modify a scheduled observation date. The observe selection element 112 provides access to the predetermined observation form module 64 and learner identified in the observation calendar module 106.

Referring again to FIG. 13, the observation calendar module 106 is configured to permit the user to enter a date into the calendar start week entry field 116, indicate the show weekend selection element 118 desired, and select the view selection element 120 thereby generating the calendar output 122. In the embodiment in FIG. 13, the calendar output 122 includes events corresponding to information in the legend 114. In one embodiment, the events include “Completed Observation,” “Incomplete Observation,” “Overdue Observation,” “Today,” “Weekend,” and “Scheduled Observation.” As will be understood by those skilled in the art, in other embodiments, other events may be included and/or the above events may be omitted. As illustrated in FIG. 13, the only events in the calendar output 124 include an “Overdue Observation” on May 21, 2008 and a “Scheduled Observation” on May 28, 2008. The observation calendar module 106 permits the observer 194 and/or administrator 192 to monitor past and future observations for a specific individual or several individuals.

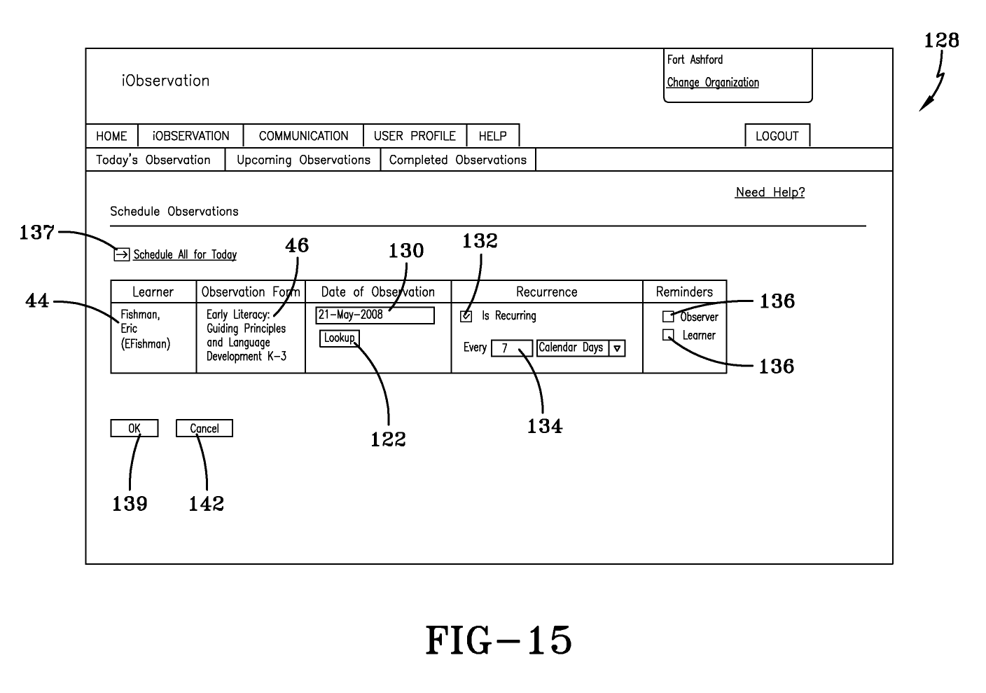

Referring to FIG. 14, an exemplary embodiment of a screen providing observation history module 126 accessed by selecting the history selection element 108 depicted in FIG. 13 is shown. In FIG. 14, the observation history module 126 includes an exemplary observation history chart. The observation history module 126 includes the calendar start week entry field 116, the view selection element 120, the date lookup selection element 122, the calendar output 124, the print selection element 98, and the close selection element 100. In this embodiment, the calendar output 124 is displayed in a graphical manner indicating the numeric value of the rating level 148. In this illustration, the rating level 148 has a numeric value of 1 for May 16, 2008, a numeric value of 3 for May 22, 2008, a numeric value of 2 for May 27, 2008, a numeric value of 3 for Jun. 2, 2008, and a numeric value of 3 for Jun. 13, 2008. In this illustration, the selected observation criteria selection element 70 is depicted as having been selected as “Oral Language Development.” In the embodiment illustrated in FIG. 14, observation history module 126 can be opened, minimized, or modified in size to permit access to the observation history module 126 while an individual is completing the predetermined observation form 64. The observation history module 126 permits the observer 194, administrator 192, and/or the learner to monitor whether the learner has grown in a predetermined area over a period of time.

Referring to FIG. 15, an exemplary embodiment of a screen providing a schedule observations module 128 accessed by selecting the reschedule selection element 110 depicted in FIG. 13 is shown. In FIG. 15, the schedule observations module 128 includes an exemplary scheduling tool for scheduling observations. The schedule observations module 128 includes a date of observation entry field 130, the date lookup selection element 122, an identification of predetermined observation form 64, an identification of the learner, a recurrence selection element 132, a recurrence frequency selection element 134, reminder selection elements 136, a schedule all for today selection element 137, an OK selection element 139, and a cancel selection element 142. In this embodiment, entering a date into the date entry field 130, selecting the recurrence selection element 132, selecting the frequency of the recurrence frequency selection element 134, selecting the reminder selection elements 136, and selecting the OK selection element 139 thereby provides the selected recipients with a reminder for each scheduled observation and updates the observation calendar module 106 accordingly. Those skilled in the art will understand that the selection elements can be selected in countless configurations thereby generating countless updates to the observation calendar module 106. The schedule observations module 128 permits the observer 194 and/or administrator 192 to schedule observations by employing an algorithm to track compliance and identify completion of certain actions meeting predetermined objectives. In one embodiment, the calendaring module 106 interoperates with existing calendaring tools as commercially available (e.g. through Outlook, LotusNotes, Hotmail, Yahoo, Gmail, etc.).

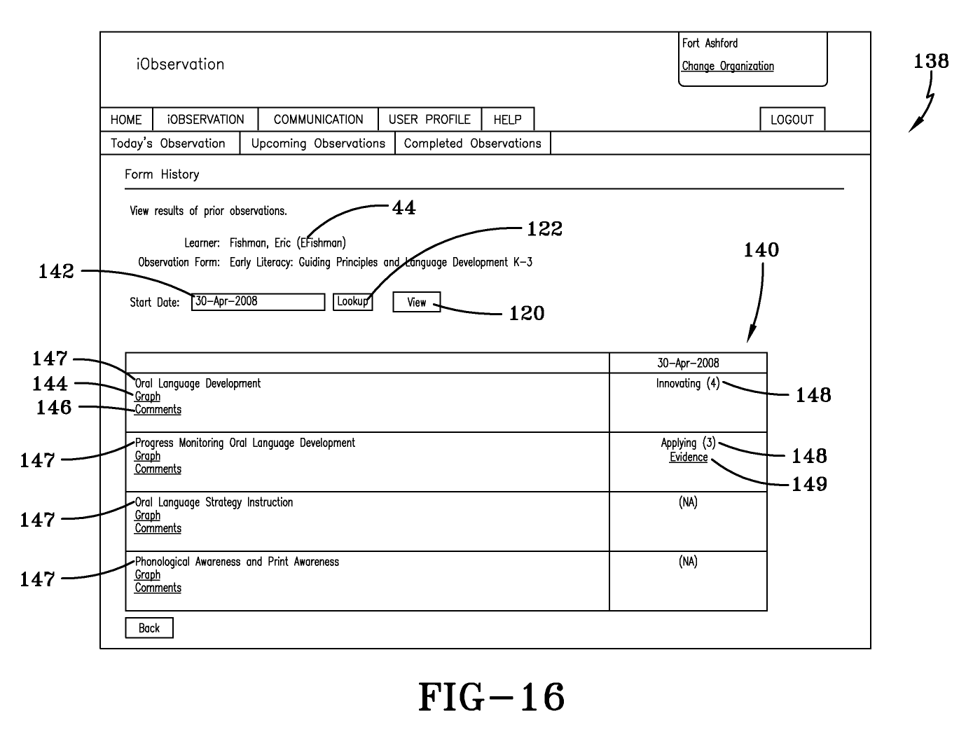

Referring to FIG. 16, an exemplary embodiment of a screen providing form history module 138 accessed by selecting one of the action selection elements 57 is shown. In FIG. 16, the form history module 138 includes an exemplary tool for accessing prior observation records. In this embodiment, the action selection element 57c depicted as having been selected is the “View Form History” action selection element 57c. The form history module 138 includes an observation summary 140, the view selection element 120, the date lookup selection element 122, and a start date entry 142. The observation summary 140 further includes an identification of the observation criteria 147, graph selection elements 144, comments selection elements 146, and displayed rating levels 148. The observation module 128 permits the observer 194, administrator 192, and/or learner to view the rating levels 148 for the learner on a predetermined date categorized by observation criteria 147.

In the embodiment illustrated in FIG. 16, the identification of the observation criteria 147 includes all of the observation criteria, whether completed or not. In another embodiment, only the completed observation criteria is displayed. The graph selection elements 144 correspond to the identified observation criteria 147. Upon selecting the graph selection elements 144, a user accesses the corresponding graph as described above in relation to FIG. 14. Upon selecting the comments selection elements 146, a user accesses the corresponding comments as described in relation to FIG. 8. The displayed rating levels 148 correspond to the information entered into the observation form module 64 described in FIGS. 7 through 9.

In FIG. 16, the “Oral Language Development” observation criteria 147 has the rating level 148 with the numeric value 4. In FIG. 16, the “Progress Monitoring Oral Language Development” observation criteria 147 has the rating level 148 with the numeric value 3. In addition, FIG. 16 illustrates an embodiment including an evidence selection element 149 corresponding to the “Progress Monitoring Oral Language Development” observation criteria 147. This evidence selection element 149 corresponds with the student and/or professional evidence downloaded in the observation form module 64. In the embodiment in FIG. 16, if the corresponding observation form module 64 does not include a rating level 148, then the displayed rating level 148 is indicated as NA.

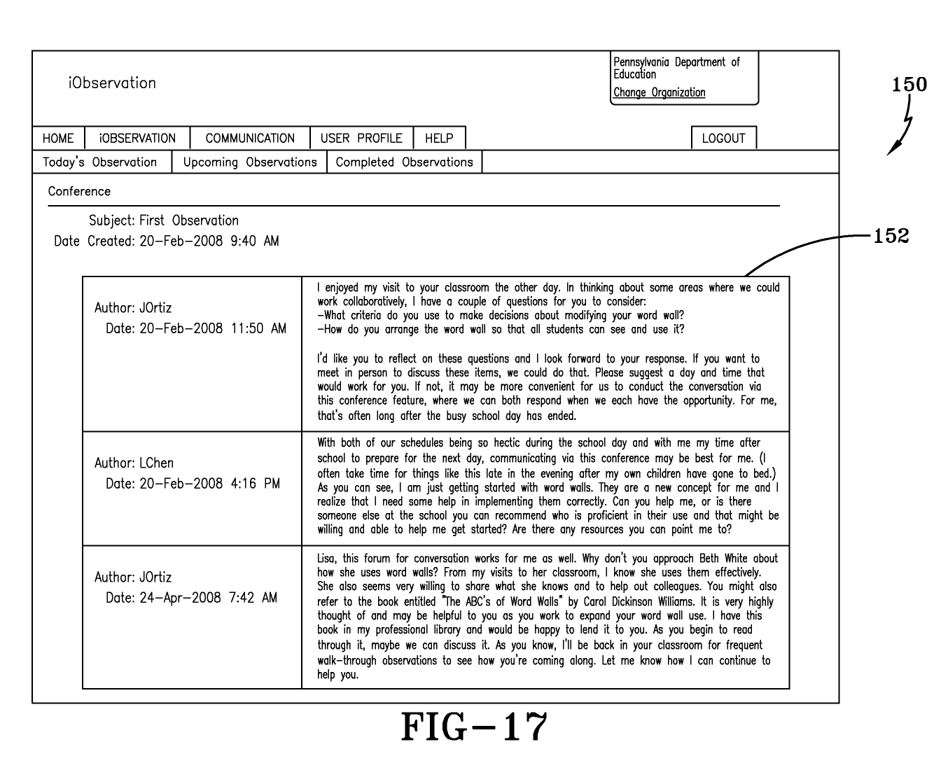

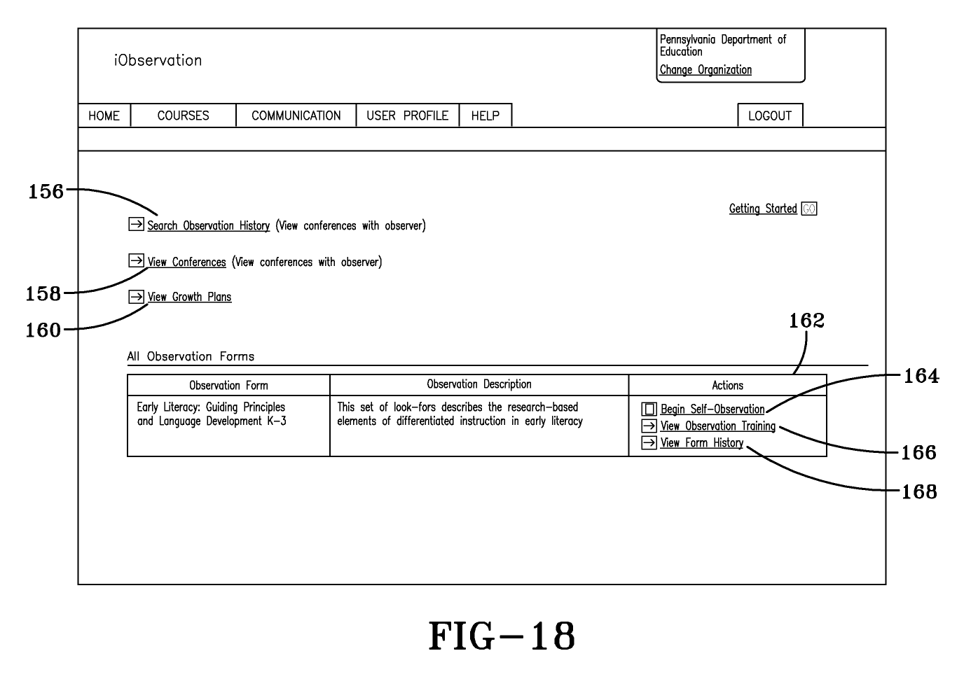

Referring to FIG. 17, an exemplary embodiment of a screen providing conference module 150 accessed by selecting one of the action selection elements 57 is shown. In FIG. 17, the conference module 150 includes an exemplary conference summary tool. In this embodiment, the action selection element 57 is the “Conferences” action selection element 57d. The conference module 150 is a system for communicating. In FIG. 17, the system depicted is a dated web log 152. In another embodiment, an email system archiving the emails to remain available to both the learner or professional and the observer is used. In one embodiment, the conference module 150 illustrated by FIG. 17 may be used for the principal conference step 24 portion of one embodiment of the growth cycle 12. The conference module 150 permits the observer 194, the administrator 192, and/or the learner to review comments over a period of time to reflect upon the development and progress (or lack of progress) of the learner.

Upon completing module illustrated by FIGS. 4 through 17, the immediate and explicit feedback step 18 is begun by the professional. The immediate and explicit feedback step 18 is begun by the professional selecting the Professional Growth Tab element 35c in FIG. 4.

Referring to FIG. 18, an exemplary embodiment of a screen providing professional growth module 154 accessed by selecting the Professional Growth Tab element 35c depicted in FIG. 4 is shown. In FIG. 18, the growth module 154 includes an exemplary self-observation tool. The professional growth module 154 includes a search observation history selection element 156, a view conferences selection element 158, a view growth plans selection element 160, and an observation form table 162. Selecting the search observation history selection element 156 permits the professional to access the observation history module 126 identifying the professional as the learner. Selecting the view conferences selection element 158 permits the professional to access the conference module 150 applicable to the professional. The observation form table 162 further includes a begin self-observation selection element 164, a view observation training selection element 166, and a view form history selection element 168. Selecting the view form history selection element 168 permits the professional to access the form history module 138 identifying the professional as the learner. The professional growth module 154 permits the learner to reflect upon the learners past performance, prepare for an observation by reviewing the observation training materials, and focus on achieving success in the observation thereby performing the growth cycle 12.

Selecting the view observation training selection element 166 provides access to a set of courses focusing on specific skills necessary to prepare for observing learners. Examples of the courses include, but are not limited to, courses focusing on reading-writing connection, developing comprehension, developing independent readers, differentiating small group instruction, early literacy, fluency and vocabulary, high impact instructional strategies, classroom curriculum design, teaching authentic, and understanding specific state guidelines.

Selecting the begin self-observation selection element 164 permits the professional to access module similar or identical to the observation form module illustrated by FIGS. 4 through 17.

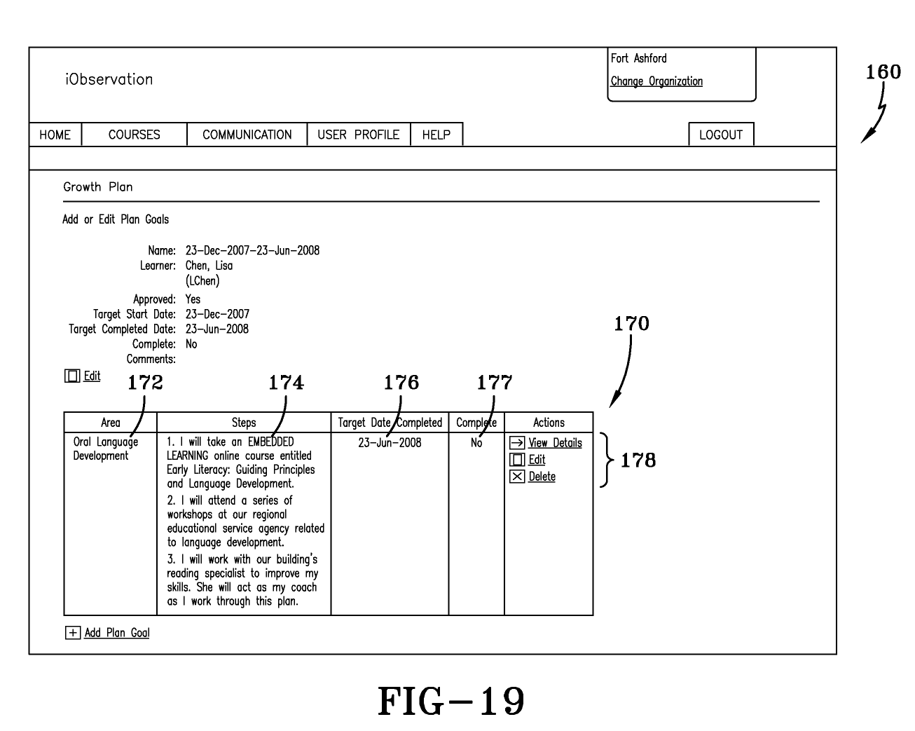

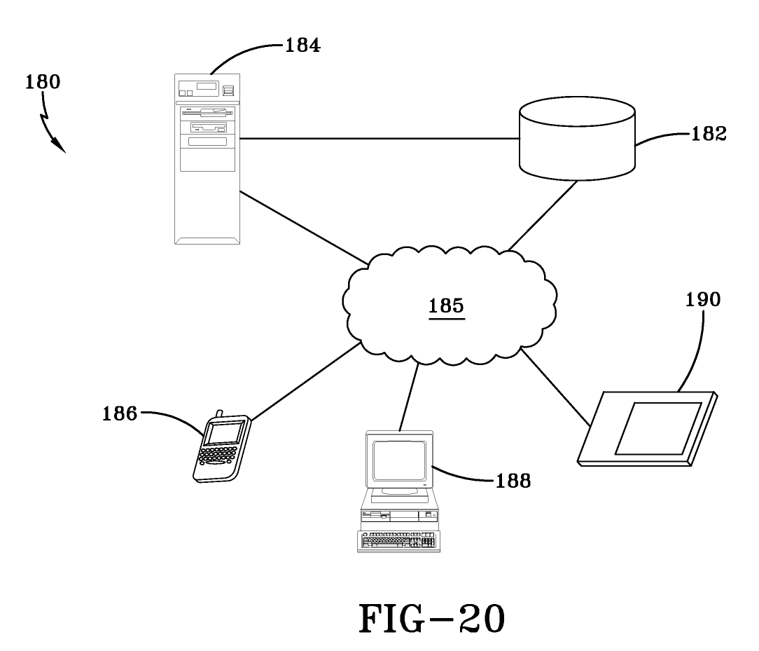

Selecting the view growth plans selection element 160 illustrated in FIG. 18 permits the professional to access growth plan module 160 (described in FIG. 19). As illustrated by the exemplary embodiment in FIG. 19, the growth plan module 160 includes a developed growth plan 170. The developed growth plan 170 permits the professional to perform the professional reflection & implementation/application step 20. In FIG. 19, the growth plan module 160 includes an exemplary growth plan. In one embodiment of the growth plan 170, the developed growth plan 170 additionally permits the professional to perform the professional self-assessment/growth plan with differentiated professional development 26. The developed growth plan 170 includes an identification of a development area 172, delegated steps 174 to accomplish the growth, a target completion date 176, an indication 177 of whether the developed growth plan 170 has been completed, and selection elements 178 relating to the area to be developed. In the embodiment illustrated in FIG. 19, the development area 172 is “Oral Language Development.” In one embodiment, the delegated steps 174 include taking a course, attending workshops, and working with a reading specialist. As will be understood by those skilled in the art, more or fewer steps may be incorporated into the developed growth plan 170. As illustrated in the embodiment in FIG. 19, the target completion date 176 is Jun. 23, 2007, the indication 177 states that the growth plan 170 has not been completed, and the selection elements 178 permit access to further details and the ability to edit or delete the growth plan 170. The growth plan module 160 permits the learner to have a concrete idea of steps that can be taken to achieve professional success. In addition, the growth plan module 160 permits the observer 194 and/or administrator 192 to quantify progress (or a lack of progress) on the part of the learner.

Referring to FIG. 20, an exemplary embodiment of a hardware architecture system 180 according to the present invention is shown. The hardware architecture system 180 permits the facilitation of growth of individuals in their professional practice through the process of frequent onsite observations and ongoing communication between observers 194 and professionals by providing means for the communication, storage, and viewing of information pertinent to accomplishing the growth cycle 12. In the embodiment illustrated in FIG. 20, the hardware architecture system that forms the communication network is preferably arranged as a client-server. The networked system includes at least one data storage device or database 182, a computer server having a server operating system 184, a computer network, (e.g., Internet portal) 185, and one or more digital computer devices connected to the server system 184 and the database via the network 185. Alternately, the system may be connected through various network systems including wireless, hardwired and combinations thereof. The digital computer devices include but are not limited to such computer devices as a handheld computing device or personal digital assistant (PDA) 186, a personal computer (PC) 188, and a tablet PC 190. In one embodiment, the handheld device 186, the personal computer 188, and the tablet personal computer 190 can be used interchangeably to facilitate the growth cycle 12 by accessing the Internet connection 185 before, during, or after the observation event 16.

In one embodiment, the information from the handheld device 186, the personal computer 188, or the tablet personal computer 190 is transmitted using the Internet connection 185 to the server 184. The server 184 transmits the information to the database 182 which stores the information in a retrievable format and permits the information to be retrieved by the individual using the handheld device 186, the personal computer 188, or the tablet personal computer 190. The server 184 illustrated in FIG. 20 is a web server. The database 182 illustrated in FIG. 20 is a backend database. The system includes many other components, such as printers, modems, routers, and switches etc., which are not shown in the drawings for purpose of clarity. As will be understood by those skilled in the art, various other configurations may be used for permitting the information associated with the observation event 16 or observations to be transmitted, received, stored, or accessed.

In the embodiment of the present invention illustrated by FIG. 20, the growth cycle 12 is based on an electronic, web-hosted system that can be accessed with the Internet connection 185. The device is selected from the group consisting of the handheld device 186, the personal computer 188, and the tablet personal computer 190. In one embodiment, the device is compatible with a Windows® operating system, such as Windows® 2000 or Windows® XP, include a Pentium III—500 Megahertz processor, include at least 64 Megabytes Random Access Memory (RAM), and include Internet Explorer® 5 or later version. In another embodiment, the device includes FireFox® 1.0 or later version or Opera® 8.0 or later version. In yet another embodiment, the device is compatible with Macintosh® MacOS X operating system, include Power PC G4 Megahertz, include at least 64 Megabytes of RAM, and include FireFox® 1.0 or later version, Safari® 2.0 or later version, or Camino® 1.0 or later version. In yet another embodiment, the device is configured to work in conjunction with a wireless card and Internet connectivity, include Macromedia Flash Player® 8 or later version, are compatible with headphones or speakers, are compatible with a printer, are compatible with a camera, and are compatible with a scanner. In yet another embodiment, the growth cycle 12 includes offline features.

Referring to FIG. 21, a schematic diagram representing relationships between various components of an exemplary embodiment of the growth cycle 12 is shown. In FIG. 21, the growth cycle 12 is illustrated by an entity-relationship diagram. The entities included in this representation of the growth cycle 12 include the administrator 192, the observer 194, and the learner. The learner entity is subdivided into roles of the learner, which include a learner-courses role 196, a learner-development role 198, and a learner-observation role 200. The learner-courses role 196 provides that the learner take online courses. The learner-development role 198 provides that the learner create professional development goals. The learner-observation role 200 provides that the learner participates in observations and view results.

As illustrated in FIG. 21, each of the entities has multiple relationships with other entities. These relationships can be divided into external relationships, which include an entity performing a task on another entity, and internal relationships, which include an entity having a task performed on them by another entity. The roles may be implemented through the software implementation described in FIGS. 1-19 and FIGS. 22-26. The administrator 192 external relationships include a monitors compliance 202 relationship with the observer 194, an assigns curricula 206 relationship with the learner-courses role 196, an approves plans 208 relationship with the learner-developer role 198, and a monitors progress 210 relationship with the learner-observation role 200. The observer 194 external relationships include a monitors growth 212 relationship with the learner-development role 198 and an observe learner 214 relationship with the learner-observation role 200. The learner-courses role 196 external relationships include a fuels growth 216 relationship with the learner-development role 198 and a triggers observation 218 relationship with the learner-observation role 200. The learner-developer role 198 does not include external relationships. The learner-observation role 200 external relationship includes a triggers goal achievement 220 relationship with the learner-development role 198. The internal relationships correspond to the external relationships identified above; thus, the role of the administrator 192 does not include internal relationships. The placement of a user into one of these roles permits an algorithm to perform the module of the method and system disclosed.

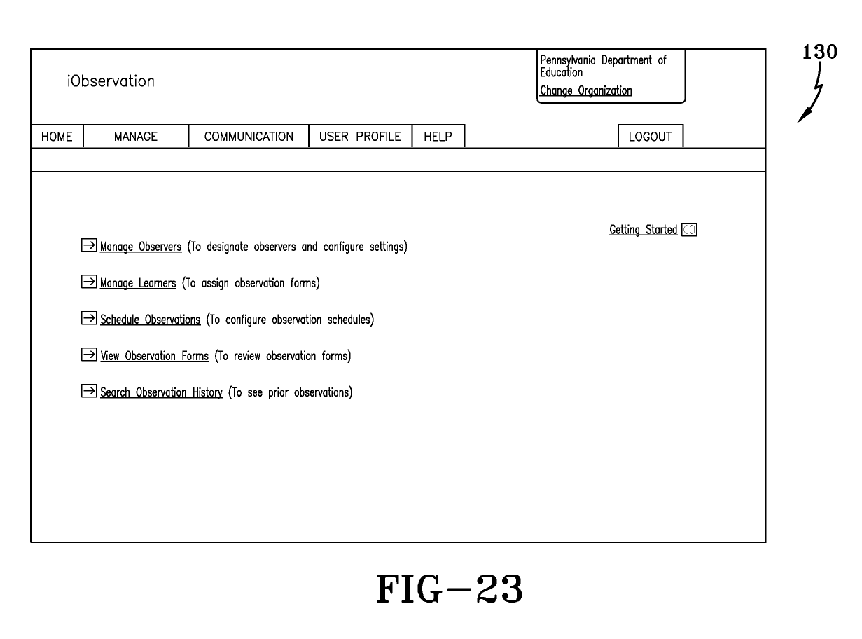

FIGS. 22 through 26 further illustrate the difference of the above roles by providing exemplary embodiments of screens accessible to administrators 192. The admin selection element 36 permits a user to access administrator module. As illustrated in the exemplary embodiment of a screen in FIG. 22, if an individual has roles as the administrator 192 and the observer 194, an intermediary screen 228 providing a predetermined school administer selection element 224 and a predetermined school observer selection element 226 may be included.

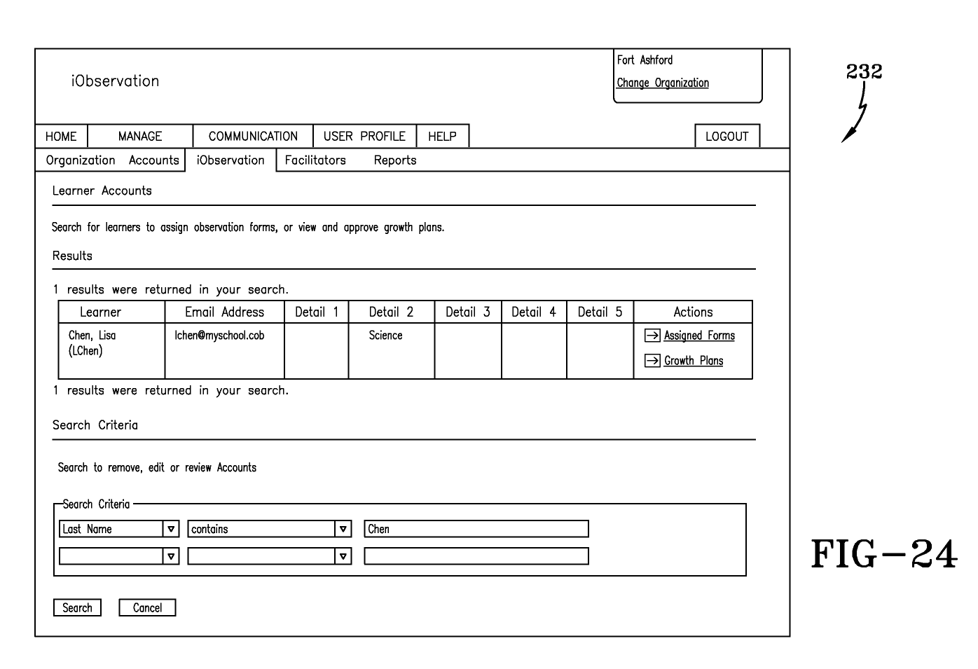

Upon selecting the predetermined school administrator selection element 224, the administrator 192 is able to monitor compliance 202 by the observer 194, assign curricula 206 to the learner-courses role 196, approve plans 208 for the learner-developer role 198, and monitor progress 210 of the learner-observation role 200. Referring to FIG. 23, an exemplary embodiment of a screen providing administrator-observer monitoring module 230 permitting the administrator 192 to monitor compliance 202 by the observer 194 is shown. In FIG. 23, the administrator-observer monitoring module 230 includes an exemplary observer account administration feature. As illustrated in FIG. 23, the administrator-observer monitoring module 230 includes selection elements enabling the administrator 192 to view information about the observer 194, view the observer 194 settings, email the observer 194, remove the observer 194, and add other observers 194.

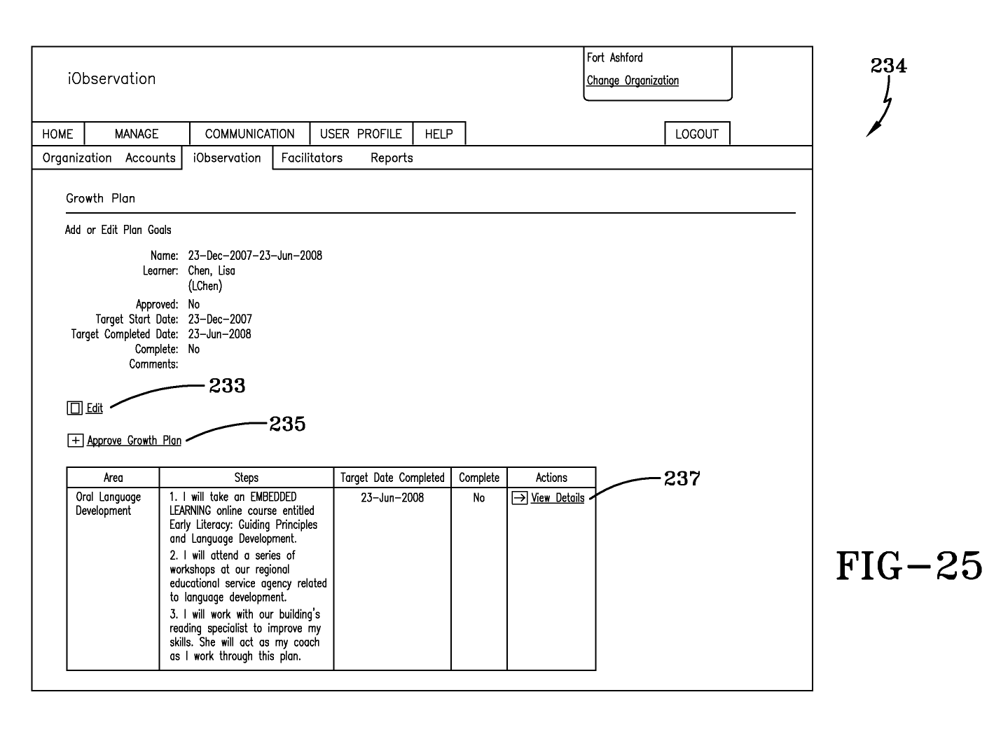

Referring to FIG. 24, an exemplary embodiment of a screen providing administrator-learner monitoring module 232 permitting the administrator 192 to assign curricula 206 to the learner, approve plans 208 for the learner, and monitor progress 210 by the learner is shown. In FIG. 24, the administrator-learner monitoring module 232 includes an exemplary learner account administration feature. As illustrated in FIG. 24, the administrator-learner monitoring module 232 includes selection element enabling the administrator 192 to assign forms, view growth plans, search learner accounts, edit learner accounts, review learner accounts, and access growth plan administrator-module 234.

Referring to FIG. 25, an exemplary embodiment of a screen providing growth plan administrator-module 234 is shown. In FIG. 25, the growth plan administrator-module 234 includes an exemplary growth plan administration feature. As illustrated in FIG. 25, the growth plan administrator-module 234 includes the ability to edit 233 the growth plan, approve 235 the growth plan, and view details 237 of the growth plan. The growth plan administrator-module 234 permits the administrator 192 to foster consistency in various growth plans by editing and approving the growth plans.

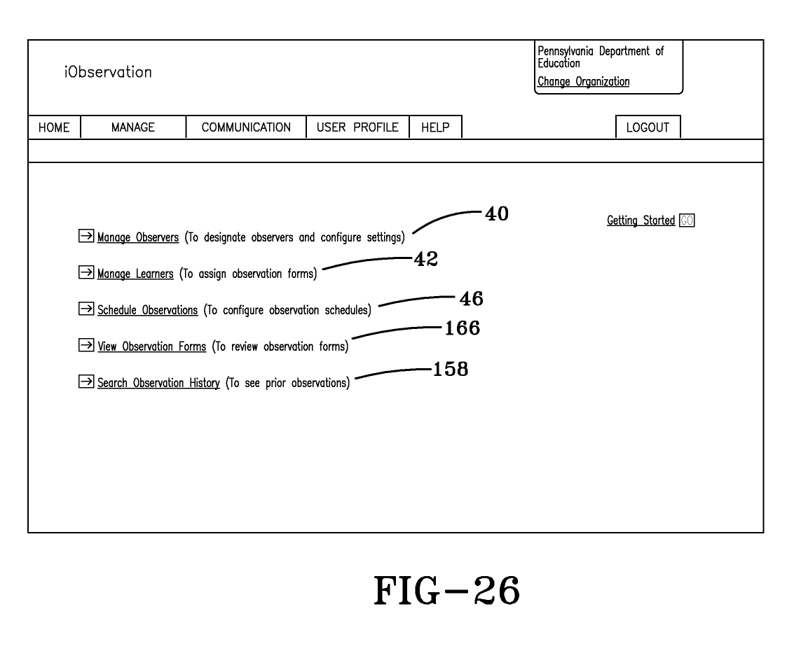

Upon selecting the predetermined school observer selection element 226, the observer 194 is able to monitor growth 212 by the learner-development role 198 and observe the learner-observation role 200. In addition, the observer 194 is able to prepare for observations. FIG. 26 illustrates an exemplary embodiment of the observation module 38. In FIG. 26, the observation module 38 includes an exemplary observer action menu feature. In this embodiment, the observation module 38 includes the today's observations selection element 40, the upcoming observations selection element 42, the completed observations selection element 46, the observation training selection element 166, and the view conferences selection element 158. The selection of the predetermined school administrator selection element 224 versus the predetermined school observer selection element 226 results in differing levels of module for the individual using the system. In one embodiment, the administrator 192 is granted access to all information, all screens, and all module. In another embodiment, the administrator 192 is given access to modify all information and all screens. In another embodiment, the observer 194 access may be similarly modified. As will be understood by those skilled in the art, the administrator 192 and observer 194 access and ability to modify content, module, and information in the system can be configured based as needed.

In one exemplary embodiment, the information gathered through the module discussed in the above paragraphs can be compiled and reported based upon certain criteria associated with the information. In one embodiment, the information can be reported based upon the role of the individual receiving the information; based upon criteria relating to the administrator 192, the observer 194, or the learner; or based upon the content of the information. For instance, regarding the role of the individual, the information can be reported based upon the specific administrators 192, observers 194, or learners. Regarding the criteria relating to the administrator 192, the observer 194, or the learner, the information can be reported based upon whether the administrator 192, the observer 194, or the learner is affiliated with a specific school, district, or region. Regarding the content of the information, the information can be reported based upon grade levels, subject areas, and other similar criteria. When the information is reported based upon the criteria, the information may be used by school administrators 192, school boards, government entities, or any other individual or organization that has an interest in monitoring trends and progress of students, schools, teachers, and/or administrators. In other embodiments, the criteria for reporting the progress of these individuals, or other similar individuals, may be modified.

While the invention has been described with reference to a preferred embodiment, it will be understood by those skilled in the art that various changes may be made and equivalents may be substituted for elements thereof without departing from the scope of the invention. The elements and aspects of the illustrations represent functions. Certain functions may be added or deleted. Access or ability to modify certain functions may differ between certain roles and certain individuals. Many modifications may be made to adapt a particular situation to the teachings of the invention without departing from the essential scope thereof. This is especially true for adaptation of the above disclosure as it applies to growth of professionals outside of the teaching profession. Therefore, it is intended that the invention not be limited to the particular embodiment disclosed as the best mode contemplated for carrying out this invention, but that the invention will include all embodiments falling within the scope of the appended claims.

1. A computer based system for conducting observations of individual professionals and administering observation results in a professional growth cycle, the system comprising:
an observation software module configured to generate from a predetermined list of learners a listing of at least one learner for a scheduled observation event by a predetermined observer;
a plurality of predetermined action element options selectable by the observer, each of the action elements related to the scheduled observation event;
a scheduling module in data communication with a calendar module, the scheduling module configured to enter data and extract data associated with one or more observation events from the calendar module; and
an observation criteria module configured to generate at least one observation criteria from a plurality of observation criteria for guiding the observer in conducting the observation event.

2. The system of claim 1, wherein the plurality of predetermined action element options comprises:
a begin observation selection to commence an observation event associated with the at least one individual;
a view observation calendar element;
a view form history to view observation forms associated with the at least one individual;
a conferences element to select a conference module for communication between at least one observer and at least one individual; and
a view observation training element to view training materials associated with the scheduled observation.

3. The system of claim 2, wherein the begin observation element comprises accessing at least one observation form, each observation form comprising:
at least one observation criteria associated with the scheduled observation event; a rating portion having a plurality of selectable rating options to rate the learner; an evidence module having a plurality of evidentiary criteria, each evidentiary criteria selectable by the observer to identify evidentiary criteria applicable to the observation event to provide evidentiary support to the rating option selected by the observer.

4. The system of claim 3, wherein the begin observation element further comprises at least one of the following:
a text entry portion to enter additional evidentiary criteria and comments associated with the scheduled observation event;
an automatic email notification element selectable to generate an email to the individual related to the scheduled observation event; or
an attachment element configured to attach electronic documents to the observation form.

5. The system of claim 3, wherein the at least one observation form further comprises a rubric selection element for displaying at least one predetermined rubric associated with the scheduled observation, wherein the at least one predetermined rubric comprises a description for each rating option of the plurality of rating options.

6. The system of claim 3, wherein the at least one observation form further comprises at least one coaching suggestion wherein the at least one coaching suggestion comprises explanations corresponding to the rating levels and suggestions for further development of the individual subject to the scheduled observation.

7. The system of claim 2, further comprising an audio-visual model selectable by an observer to illustrate a professional performing an exemplary action according to at least one observation criteria.

8. The system of claim 2, further comprising an observation calendar module configured to display a selectable range of dates, and one of: a history of completed observation events; an indication of dates of incompleted observation events; an indication of dates of overdue observation events; scheduled observation events; and combinations thereof.

9. The system of claim 8, further comprising an observation history selection element configured to display a graphic display of a plurality of dates of observation events and ratings associated with the learner on the displayed dates.

10. The system of claim 1, further comprising a scheduling module configured to designate at least one date for an observation event for a predetermined learner, an observation form associated with the observation event, and to automatically transmit a reminder message to at least one of the observer and learner.

11. The system of claim 1, further comprising a form history module in data communication with the calendar module, the form history module configured to generate a listing of completed observation forms for the individual learner associated with a preselected observation date.

12. The system of claim 1, further comprising a conferencing module configured for entering text communications between at least the observer and the individual associated with the scheduled observation event.

13. The system of claim 1, further comprising an individual growth plan module configured to be entered by the individual a self-assessment and a professional growth plan associated with the scheduled observation, the professional growth plan comprising at least one goal for the individual to achieve.

14. The system of claim 13, wherein the observation software module is configured to apply an algorithm to track training sessions associated with an individual to determine that the at least one goal has been achieved

15. The system of claim 14, wherein the observation software module determines that the at least one goal has been achieved in response to the learner scoring a predetermined rubric level at least a predefined number of times within a predetermined number of observations.

16. The system of claim 15, wherein the predetermined rubric level, the predefined number of times, and a time span defined by the predetermined number of observations are configurable by an administrator.

17. The system of claim 1, further comprising a learner module configured to:
permit a learner to: participate in at least one training session;
receive at least one result related to observations submitted by an observer;
perform at least one assessment of the learner or a peer;
develop at least one growth plan; and
participate in a bidirectional feedback session.

18. The system of claim 1, wherein the observer software module is further configured to permit the observer to:
review growth plans, review training related to observations, schedule observations, conduct observations, provide feedback, and review improvement related to a learner over one or more growth cycles.

19. The system of claim 1, further comprising an administrator module configured to permit an administrator to: assign at least one observation, assign one or more observers to perform the at least one observation, assign learners to be observed during the at least one observation, review growth plans related to the at least one observation, view reports associated with the at least one observation, assign training materials, and create new observation forms

20. A computer implemented method for individual and organizational professional development using a professional growth cycle including growth planning, training, observation, feedback, and improvement comprising:
providing an observer module, an observation module and an administrator module;
through the observer module, generating over a computer network a listing of one or more observations to be performed by an observer on a predetermined date, the listing including at least one individual subject for observation, a calendar date of a scheduled observation associated with the individual subject and a plurality of action selection elements; and
performing at least one of the following steps:
observing at least one of the individual subjects in a professional environment;
viewing an observation calendar associated with the individual subject;
accessing a collection of electronic observation forms;
communicating with the individual subject via a conferencing module; or
viewing an observation training module associated with an observation form for the individual subject.

21. The method of claim 20, wherein the step of observing includes accessing one or more observation forms, the observation forms comprising guidelines to be followed by an observer performing the observation.

22. The method of claim 20, further comprising the step of:
through the learner module, accessing by the individual course materials and course-related information through the network and selecting a list of course offerings; receiving the results of observations; performing self or peer assessment; developing growth plans, and participating in bidirectional feedback.

23. The method of claim 20, further comprising accessing an administrator module, the administrator module configured to administer, facilitate, monitor, observe and manage observation data.

24. The method of claim 23, further comprising the steps of:
through the administrator module, assigning curricula, approving plans for the learner, monitoring progress of the learner, assigning forms, viewing at least one growth plan, searching at least one learner accounts, editing the at least one learner accounts, reviewing the at least one learner accounts, and accessing growth plan, by an administrator.
